(19) United States
(12) Patent Application Publication
(10) Pub. No.: US 2012/0218573 A1
(43) Pub. Date: Aug. 30, 2012

(54) IMAGE PROCESSING APPARATUS AND IMAGE FORMING APPARATUS

(75) Inventors: Shuji Otsuka, Shiojiri-shi (JP); Ryuichi Tsuji, Shiojiri-shi (JP); Keita Maeza, Matsumoto-shi (JP); Kazusei Obikawa, Shiojiri-shi (JP); Satoru Shibata, Shiojiri-shi (JP)

(73) Assignee: SEIKO EPSON CORPORATION, Tokyo (JP)

(21) Appl. No.: 13/371,266

(22) Filed: Feb. 10, 2012

(30) Foreign Application Priority Data
Feb. 25, 2011 (JP) 2011-040696

(51) Int. Cl. H04N 1/60

(52) U.S. Cl. 358/1.9

(57) ABSTRACT

An image processing apparatus includes a plurality of cores that carry out binarization processes while shifting a target pixel from the first pixel in a processing line in order toward the last pixel in the processing line in accordance with a diffusion of error that takes unprocessed pixels surrounding the target pixel including the pixels of the following line of the processing line as a diffusion range; of the plurality of cores, the core that processes the following line carries out the binarization process in order while delaying the target pixel at least by an amount equivalent to the diffusion range relative to the target pixel of the core that processes the previous line. Accordingly, the lines can be processed in parallel while reflecting the error appropriately on the unprocessed pixels, and thus the binarization process using error diffusion can be carried out more quickly.

This application claims the benefit of Japanese Application No.2011-040696, filed Feb. 25, 2011, all of which are hereby incorporated by reference.

### BACKGROUND

1. Technical Field

The present invention relates to image processing apparatuses that carry out a binarization process through error diffusion on the pixels of multitone image data in order from a starting line to a final line, and to image forming apparatuses provided with such image processing apparatuses.

2. Related Art

Thus far, an image processing apparatus that binarizes the pixels in multitone image data through error diffusion has been proposed (for example, see JP-A-10-164365). This apparatus binarizes the pixels in order using a single error diffusion processing unit.

Here, “error diffusion” sequentially diffuses error arising from the binarization of a processing target pixel (hereinafter called “target pixel”) throughout the unprocessed pixels that surround the target pixel, and thus there is a higher processing burden as compared to, for example, a dithering method that simply compares the value of each pixel with a threshold value. Meanwhile, the number of pixels in image data is rising in recent years as the resolution of images increases, and thus an apparatus such as that mentioned above, where a single error diffusion processing unit carries out the binarization, requires a large amount of time for processing.

### SUMMARY

It is an advantage of some aspects of the invention to provide an image processing apparatus and an image forming apparatus that quickly carry out a binarization process using error diffusion.

An image processing apparatus and an image forming apparatus according to the invention employ the following configurations in order to achieve the aforementioned advantage.

An image processing apparatus according to an aspect of the invention carries out a binarization process through error diffusion on the pixels of multitone image data in order from a leading line to a final line, and includes a plurality of processing units that carry out binarization processes while shifting a target pixel from the first pixel in a processing line in order toward the last pixel in the processing line in accordance with a diffusion of error that takes unprocessed pixels surrounding the target pixel including the pixels of the following line of the processing line as a diffusion range; of the plurality of processing units, the processing unit that processes the following line carries out the binarization process in order while delaying the target pixel at least by an amount equivalent to the diffusion range relative to the target pixel of the processing unit that processes the previous line.

With the image processing apparatus according to this aspect of the invention, there is provided a plurality of processing units that carry out binarization processes while shifting a target pixel from the first pixel in a processing line in order toward the last pixel in the processing line in accordance with a diffusion of error that takes unprocessed pixels surrounding the target pixel including the pixels of the following line of the processing line as a diffusion range, and of the plurality of processing units, the processing unit that processes the following line carries out the binarization process in order while delaying the target pixel at least by an amount equivalent to the diffusion range relative to the target pixel of the processing unit that processes the previous line. Accordingly, the lines can be processed in parallel while reflecting the error appropriately on the unprocessed pixels, and thus the binarization process using error diffusion can be carried out more quickly.

In addition, in an image processing apparatus according to another aspect of the invention, it is preferable that each of the plurality of processing units include a first in-first out buffer, be connected in pipeline form to the processing unit that processes the following line via the buffer, and output the error of a pixel that has exited the diffusion range due to the shift in the target pixel to the buffer. Through this, it is not necessary to output the error carried over to the processing unit that processes the following line in an external memory or the like, and it is thus possible to greatly reduce the time required by the processing unit that processes the following line for accessing the error carried over from the processing unit that processes the previous line. Accordingly, the binarization process can be carried out even more quickly.

In the image processing apparatus according to another aspect of the invention, it is preferable that the plurality of processing units each include, as the buffer, a later-level buffer between the processing units that process the following lines, and the target pixel be shifted under the condition that an opening has appeared in the later-level buffer. Through this, it is possible to prevent the error carried over into the processing unit that processes the following line from being unable to be outputted. Furthermore, in the image processing apparatus according to another aspect of the invention, it is preferable that the plurality of processing units each include, as the buffer, a previous-level buffer between the processing units that process the previous lines, and the target pixel be shifted under the condition that the error is stored in the previous-level buffer. Through this, the processing unit that processes the following line can be prevented from skipping the processing unit that processes the previous line.

In addition, in the image processing apparatus according to another aspect of the invention, it is preferable that the plurality of processing units start the binarization process on the processing lines under the condition that the target pixel of the processing unit that processes the previous line has been shifted at least more than an amount equivalent to the diffusion range from the start of the processing line. Through this, the processing unit that processes the following line can be prevented from starting the processing earlier than the processing unit that processes the previous line.

In an image processing apparatus according to the above aspects of the invention that uses color image data configured of a plurality of color components as the image data, it is preferable that a processing unit group configured of the plurality of processing units be provided for each of the plurality of color components. Through this, binarization processes can be carried out in parallel for each color component, and thus the image as a whole can be processed even more quickly.

It is preferable that an image forming apparatus according to another aspect of the invention include the image processing apparatus according to any of the aforementioned aspects, and form an image on a medium using data that has been binarized by the image processing apparatus.

The image forming apparatus according to this aspect of the invention includes the image processing apparatus according to any of the aforementioned aspects of the invention, and thus the same effects as the image processing apparatus achieves according to the aforementioned aspects of the invention can be achieved; that is, it is possible to process each line in parallel while reflecting the error appropriately on the unprocessed pixels, and thus the binarization process using error diffusion can be carried out more quickly.

### BRIEF DESCRIPTION OF THE DRAWINGS

The invention will be described with reference to the accompanying drawings, wherein like numbers reference like elements.

FIG. 1 is a block diagram illustrating the overall configuration of a printer.

FIGS. 2A through 2C are descriptive diagrams illustrating details of a binarization process carried out through error diffusion.

FIGS. 3A through 3C are block diagrams illustrating the overall configuration of an image processing processor for error diffusion.

FIG. 4 is a flowchart illustrating an example of a binarization process routine performed by respective cores.

FIGS. 5A through 5I are descriptive diagram illustrating a binarization process performed on a line L1 and a line L2.

FIG. 6 is a descriptive diagram illustrating a binarization process performed on an entire image.

### DESCRIPTION OF EXEMPLARY EMBODIMENTS

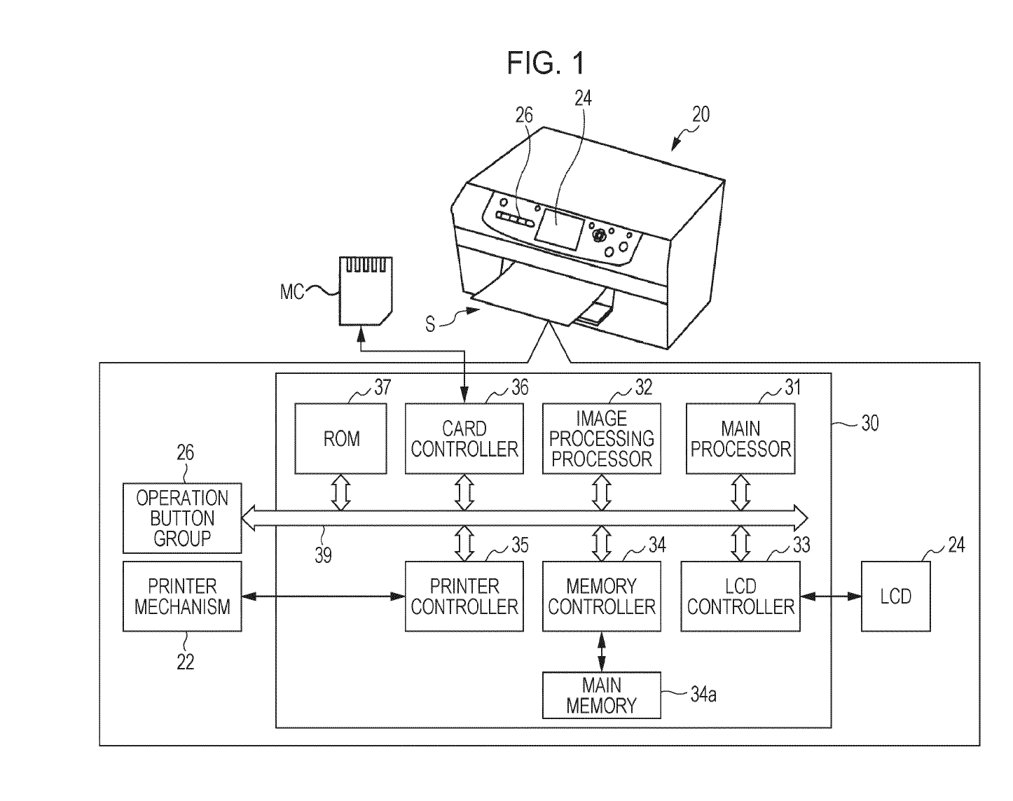

Hereinafter, an embodiment of the invention will be described using the drawings. FIG. 1 is a block diagram illustrating the overall configuration of a printer 20 as an embodiment of the invention. The printer 20 according to this embodiment includes, as shown in FIG. 1, a printer mechanism 22 that employs a known ink jet technique and that executes printing by ejecting CMYK, or cyan (C), magenta (M), yellow (Y), and black (K), inks onto recording paper S; an LCD 24 that serves as a liquid-crystal display; an operation button group 26 configured of a plurality of buttons through which a user inputs settings for various types of modes, settings necessary for printing operations, and so on; and a process control unit 30 for carrying out various types of processes for implementing control of the constituent elements of the apparatus, implementing the functions of the constituent elements of the apparatus, and so on.

The process control unit 30 includes the following elements, which are connected to each other via a bus 39 so as to be capable of exchanging various types of signals and data with each other: a main processor 31 that controls the apparatus as a whole; an image processing processor 32 that carries out various types of processes on images to be printed, images to be displayed, and so on; an LCD controller 33 that controls the display of images in the LCD 24; a memory controller 34 that reads data from a main memory 34a such as an SDRAM, writes data into the main memory 34a, and so on in accordance with instructions from the main processor 31, the image processing processor 32, and various controllers; a printer controller 35 that controls the printer mechanism 22; a card controller 36 that exchanges data with a memory card MC in which image data such as photographic images are saved; a ROM 37 in which various types of data, various types of tables, and so on are stored; and so on.

The main processor 31 is inputted with operation signals from the operation button group 26, various types of operating signals from the printer mechanism 22 via the printer controller 35, and image data from the memory card MC via the card controller 36; and writes inputted image data into the main memory 34a via the memory controller 34. In addition, the main processor 31 outputs printing instructions to the printer controller 35 for the printer mechanism 22 to execute the printing of images, display instructions to the LCD controller 33 for the LCD 24 to display various types of information, images, and so on, image processing instructions to the image processing processor 32 for carrying out various types of image processes, and so on. Note that the image data inputted from the memory card MC is, in this embodiment, RGB data in which the pixels are disposed in a vertical/horizontal matrix and each pixel value is expressed as 8 bits based on the darkness/brightness thereof (that is, 256 tones).

The image processing processor 32 converts the image data inputted from the memory card MC into image data for printing, image data for display, or the like in accordance with image processing instructions from the main processor 31. For example, if the image processing instruction is for converting the image data to image data for printing, color conversion is carried out so as to convert the 8-bit RGB data into 8-bit CMYK data, after which the post-color conversion 8-bit CMYK data is processed into 2-bit printing data (binarized data) through error diffusion. Meanwhile, if the image processing instruction is for converting the image data to image data for display, the 8-bit RGB data is processed into display data by reducing that data to a predetermined bit number that can be displayed in the LCD 24.

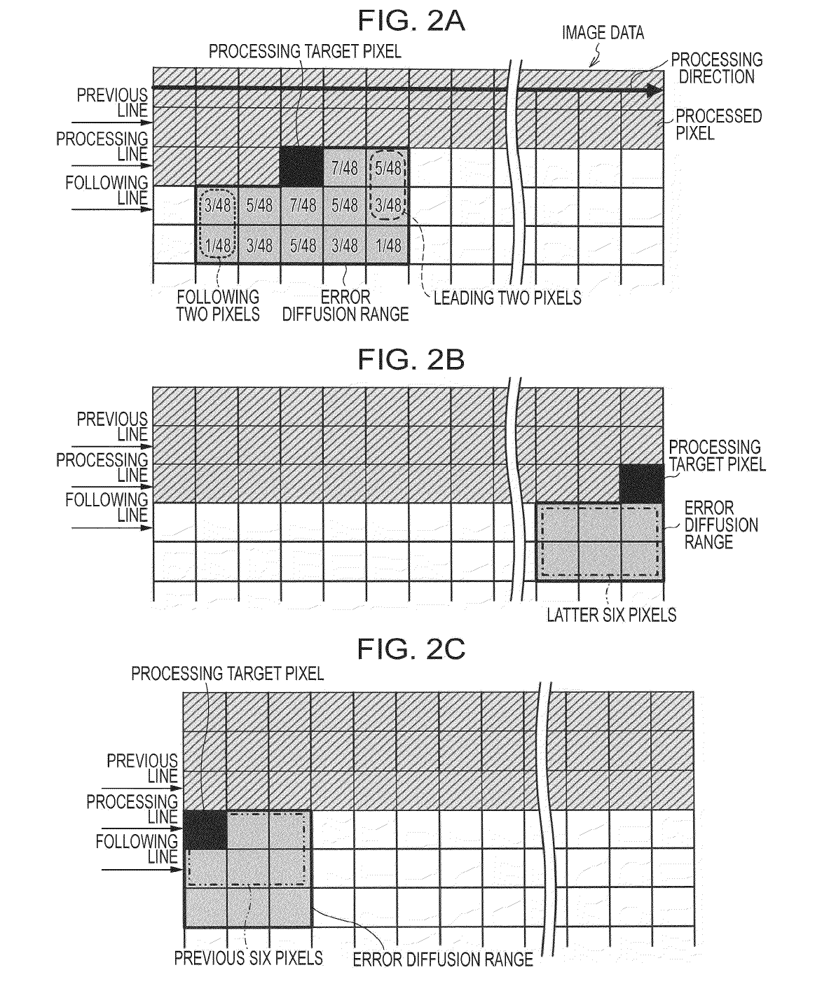

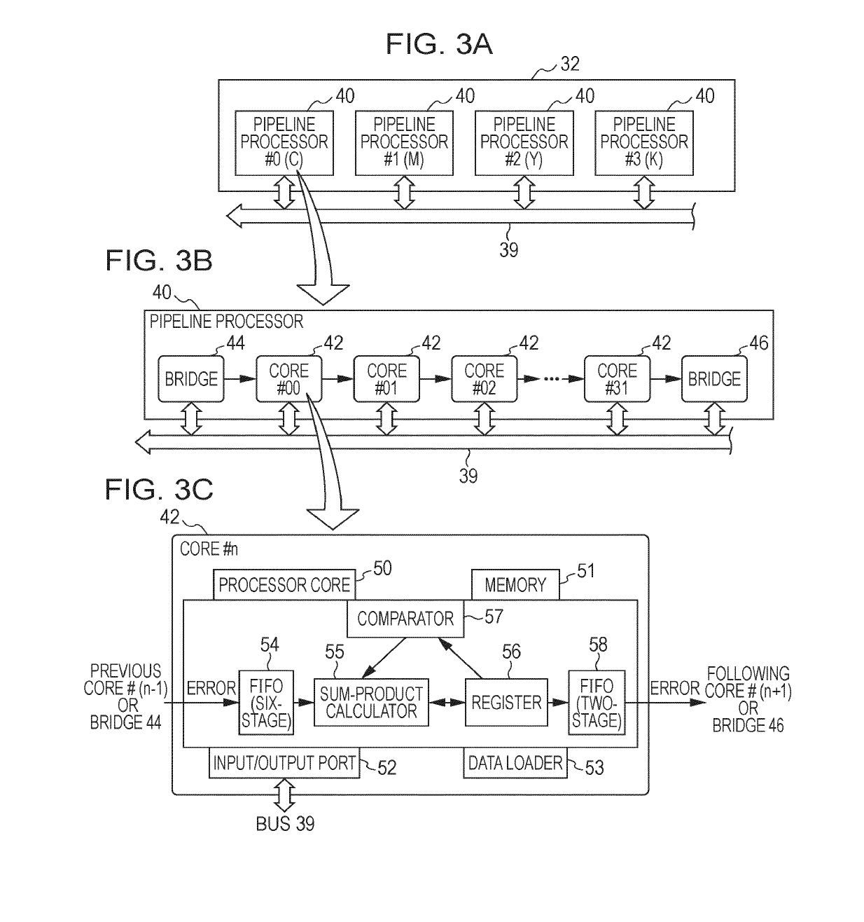

Of the processes performed by the image processing processor 32, a binarization process using error diffusion will be described next. FIGS. 2A through 2C are descriptive diagrams illustrating details of a binarization process carried out through error diffusion, whereas FIGS. 3A through 3C are block diagrams illustrating the overall configuration of the image processing processor 32 for error diffusion. In this embodiment, as shown in FIG. 2A, error arising when binarizing by comparing a target pixel with a predetermined threshold value is diffused as a diffused range of unprocessed pixels that takes the target pixel as its center (that is, a total of 12 pixels) in the surrounded 5×5 pixels. In other words, the error is diffused even into the unprocessed pixels in the line that follows the processing line. Note that the numerical values within the pixels in the error diffusion range (7/48, 5/48, and so on) indicate the percentage of error diffused into those pixels. In accordance with this error diffusion, the uppermost line in the image data is taken as the starting line, and a binarization process is carried out on a line-by-line basis moving toward the lowermost line, which is the final line. Furthermore, in each line, the pixel on the left end in the drawings is taken as the starting pixel, and the processing is carried out by sequentially shifting the target pixel toward the last pixel on the right side in the drawings (the “processing direction” in the drawings). As a result of this shift, the final two pixels exit the error diffusion range, and thus it is necessary to carry over the error from those final two pixels into the processing of the next line. To rephrase, each time the target pixel shifts, it is necessary to carry out the processing having newly inputted the error of the first two pixels of the error diffusion range (that is, carry over the processing from the previous line). In addition, when the final pixels in the processing line are processed, it is necessary to carry over the error of the latter six pixels of that error diffusion range (see FIG. 2B) into the processing of the next line, and when processing the first pixel of the processing line, it is necessary to carry over the error of the former six pixels in the error diffusion range that includes the target pixel (see FIG. 2C) from the processing of the previous line. Note that the binarization process is carried out on each of the CMYK colors for each pixel in the image data, and the predetermined threshold value is stored in the ROM 34 and expanded in the main memory 34a.

Meanwhile, the image processing processor 32 includes, as a configuration for error diffusion, a plurality of pipeline processors 40 (#0 through #3), as shown in FIG. 3A. These pipeline processors 40 are each capable of being individually inputted with pixel values and performing a binarization process thereon, and in this embodiment, each of the pipeline processors 40 handles the processing of a respective CMYK color. In addition, as shown in FIG. 3B, each of the pipeline processors 40 is configured of: a plurality of cores 42 (#00 through #31) connected in pipeline form; a bridge 44 disposed before the first core 42 (#00); and a bridge 46 disposed after the final core 42 (#31).

Each of the cores 42 (#n) is, as shown in FIG. 3C, configured of: a processor core 50 that controls the core 42 as a whole; a memory 51 configured of an SRAM or the like; an input/output port 52 connected to the bus 39; a data loader 53 that loads data via the input/output port 52 and saves the data in the memory 51; a previous-stage FIFO 54 that holds data according to the first in-first out system; a sum-product calculator 55 that calculates the error for each pixel; a register 56 that temporarily holds the results of the calculations; a comparator 57 that compares a value in which the error has been added to the value of the target pixel with a predetermined threshold value; and a later-stage FIFO 58 that holds data according to the first in-first out system. The data loader 53 loads data such as the predetermined threshold value expanded in the main memory 34a, the individual pixel values of the image data, and so on, and saves that data in the memory 51. Meanwhile, the sum-product calculator 55 calculates the error for the respective pixels by multiplying the error resulting from binarizing the target pixel by the diffusion percentage of the respective pixels and sequentially adding the results of that multiplication to the previous calculation result stored in the register 56. Although not shown in the drawings, it should be noted that a plurality of (for example, 10 or 12) sum-product calculators 55 are assumed to be provided. Then, the comparator 57 compares a value in which, of the errors stored in the register 56, the error of the target pixel is added to the pixel value of the target pixel saved in the memory 51, with the predetermined threshold value saved in the memory 51, thus binarizing the value, and outputs the error resulting from the binarization to the sum-product calculator 55. Meanwhile, the previous-stage FIFO 54 is connected to the later-stage FIFO 58 of the previous core 42 disposed in the previous stage (#n−1), whereas the later-stage FIFO 58 is connected to the previous-stage FIFO 54 of the following core 42 disposed in the following stage (#n+1). Here, in the binarization process, as the target pixel shifts, the errors of the final two pixels that exit the error diffusion range are outputted to the later-stage FIFO 58 and the errors of the starting two pixels that newly enter the error diffusion range are inputted from the previous-stage FIFO 54; the errors of the other pixels in the error diffusion range are inputted/outputted to/from the register 56. Note that in this embodiment, the previous-stage FIFO 54 is configured of a six-stage FIFO so as to be capable of storing the error of six pixels, whereas the later-stage FIFO 58 is configured of a two-stage FIFO so as to be capable of storing the error of two pixels.

In addition, although the configurations of the bridges 44 and 46 will not be described in detail, the bridge 44 is disposed before the first core 42 (#00), and outputs an error value of 0 to the first core 42 (#00) as dummy error data, outputs an error saved in the main memory 34a to the first core 42 (#00), and so on. Meanwhile, the bridge 46 is disposed after the final core 42 (#31), and outputs the error outputted from the final core 42 (#31) to the main memory 34a.

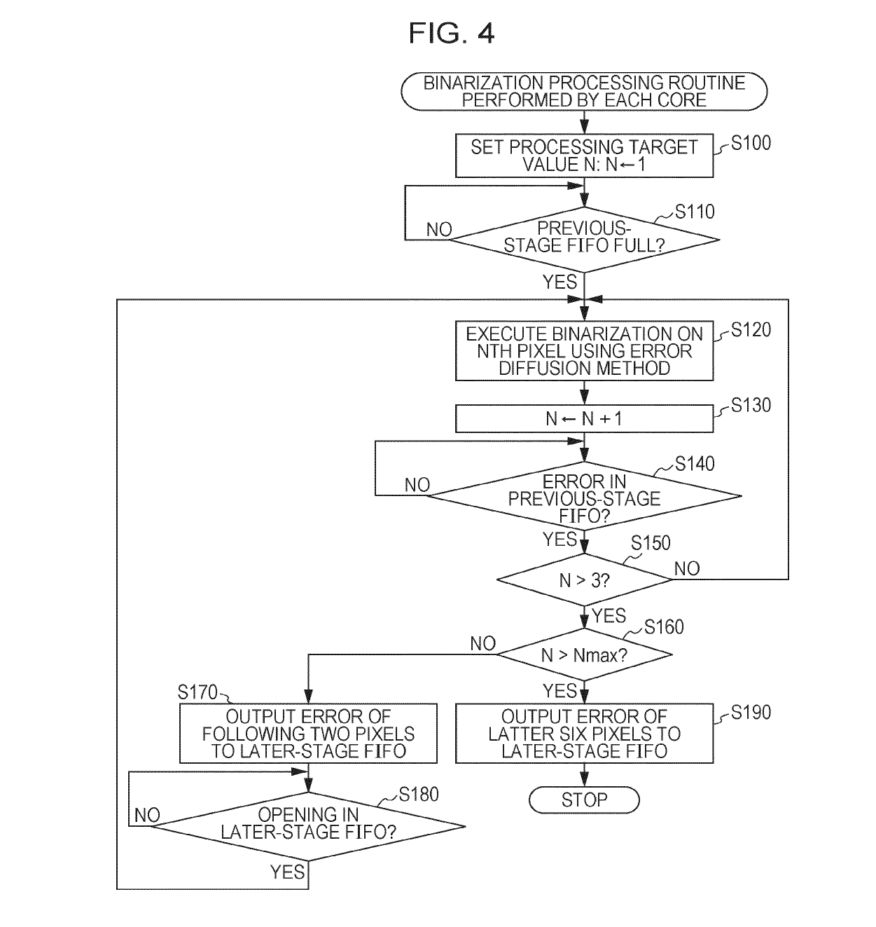

Next, operations performed by a multifunction printer 20 according to this embodiment and configured in this manner, and particularly a binarization process performed by the pipeline processors 40 of the image processing processor 32, will be described. FIG. 4 is a flowchart illustrating an example of a binarization processing routine performed by the respective cores 42 of the pipeline processors 40. Note that in this embodiment, the execution of the binarization processing routine is started by each core 42 at the same time; hereinafter, processes that are common for all cores 42 will be described, with descriptions being added as appropriate in the case where a core 42 that performs partially different processes is present. The core 42 (#00) processes the first line, the core 42 (#01) processes the second line, and the lines that follow thereafter are processed in order by the following cores 42, in the order in which the cores 42 are connected. Note that the 33rd line is processed by the core 42 (#00) that has completed processing the first line, and the respective lines are processed in the same processing order thereafter.

When the binarization processing routine is executed, the processor core 50 first sets a value of 1 for a processing target value N (step S100), and stands by until the previous-stage FIFO 54 is full (step S110). This process is a process that stands by until, in the core 42 (#00), six pixels' worth of the error of a value 0 (that is, dummy data) inputted from the bridge 44 has been stored in the previous-stage FIFO 54; in the other cores 42, the process stands by until six pixels' worth of the error inputted from the previous core 42 has been stored in the previous-stage FIFO 54. Note that this six pixels' worth of error corresponds to the error of the former six pixels shown in FIG. 2C. Then, when the previous-stage FIFO 54 is full, the binarization process through error diffusion is executed using the Nth pixel (here, the first pixel in the line) as the target pixel (step S120).

When the binarization process is executed in this manner, the processing target value N is incremented by 1 (step S130), and it is determined whether or not two pixels' worth of error is stored in the previous-stage FIFO 54 (step S140). For the core 42 (#00), this determination is for determining whether or not the error from the bridge 44 is stored, and for the other cores 42, it is determined whether or not the error from the previous core 42 is stored. When it has been determined in step 5140 that the error is stored in the previous-stage FIFO 54, it is then determined whether the processing target value N is greater than 3 (step S150). The reason for carrying out this determination will be given later. When the processing target value N is not greater than 3, the process returns to step S120, and the execution of the binarization process on the pixel corresponding to the processing target value N and so on is repeated. Note that when it has been determined in step S140 that the error is not stored in the previous-stage FIFO 54, the processing does not advance, and thus the process does not return to step S120 and does not carry out the binarization process. Accordingly, even if binarization processes are executed by the respective cores 42 in parallel, the binarization process is not carried out on a new target pixel as long as error is not inputted into a following core 42 from a previous core 42, which makes it possible to prevent a following core 42 from skipping a previous core 42 and performing the binarization process.

Meanwhile, when it has been determined in step S150 that the processing target value N is greater than 3, it is determined whether or not the processing target value N is greater than a maximum value Nmax (step S160). Note that the maximum value Nmax indicates the number of pixels in a single line, and thus descriptions will first be given of a case in which the processing target value N is not greater than the maximum value Nmax. When the processing target value N is not greater than the maximum value Nmax, the error of the following two pixels in the error diffusion range (see FIG. 2A) is stored in the later-stage FIFO 58 (step S170).

The apparatus then stands by until an opening appears in the later-stage FIFO 58 (step S180), whereupon the process returns to step S120, and the binarization process is executed taking the pixel having the processing target value N as the target pixel. Here, because the later-stage FIFO 58 is connected to the previous-stage FIFO 54 of the following core 42 as described above, the error stored in the later-stage FIFO 58 is outputted from the later-stage FIFO 58 if there is an opening in the previous-stage FIFO 54 of the following core 42, resulting in an opening appearing in the later-stage FIFO 58. However, in the case where, due to individual differences in the processing capabilities of the cores 42 or the like, the processing of the previous core 42 has proceeded more quickly than the processing of the following core 42 and errors have accumulated in the previous-stage FIFO 54 of the following core 42, the error will not be outputted from the later-stage FIFO 58, and thus an opening will not appear therein. In this manner, the determination carried out in step S180 involves monitoring the state of the processing performed by the following core 42, with the goal of carrying out the binarization process on the next target pixel when it is certain that the error can be carried over to the following core 42.

This processing is repeated, and when the binarization process is executed taking the rightmost pixel in the line (that is, the pixel whose processing target value N is the maximum value Nmax) as the target pixel and the processing target value N is then incremented by 1, it is determined, in step S160, that the processing target value N is greater than the maximum value Nmax. In this case, the errors of the latter six pixels in the error diffusion range (see FIG. 2B) are outputted to the later-stage FIFO 58 (step S190), and the routine ends. Note that the errors of the six pixels outputted to the later-stage FIFO 58 are sequentially carried over based on the state of the processing performed by the following core 42 (that is, whether there are openings in the previous-stage FIFO 54).

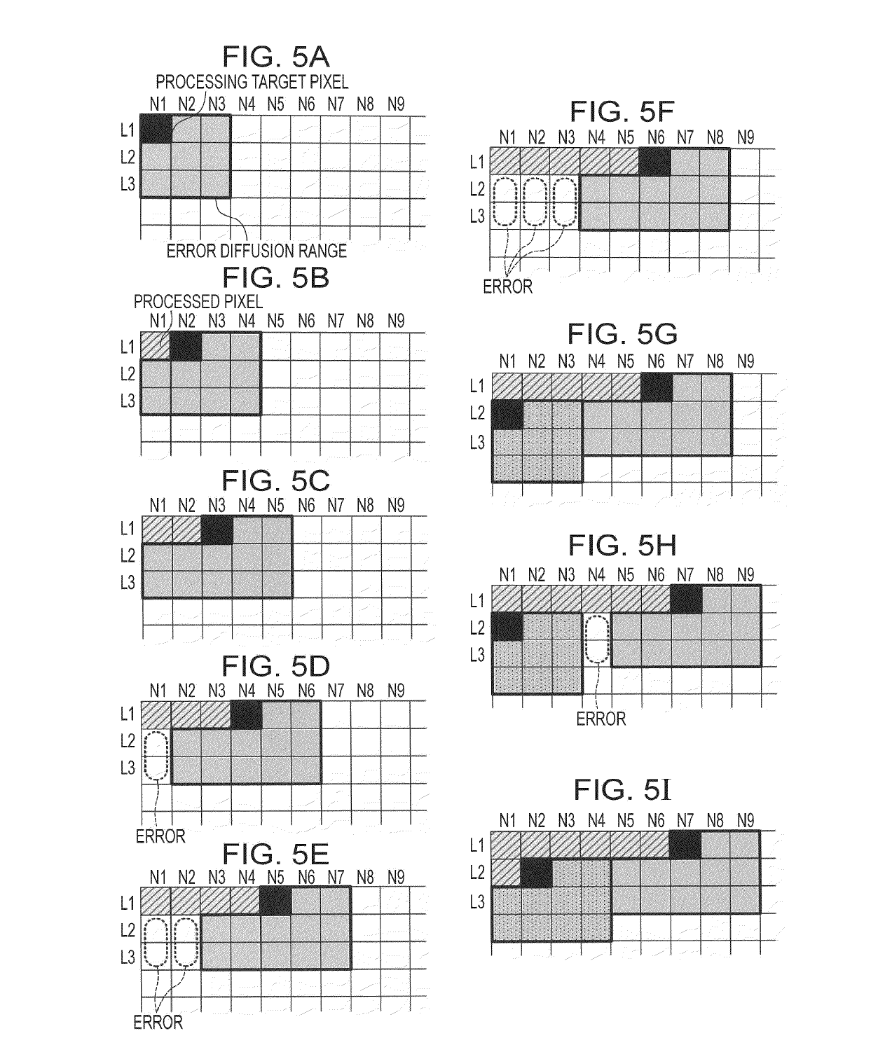

Here, a binarization process performed by the previous core 42 (#00) that handles a first line L1 of image data and the following core 42 (#01) that handles a second line L2 will be described as an example of the aforementioned binarization processing routine. FIGS. 5A through 5I are descriptive diagrams illustrating a binarization process performed on the line L1 and the line L2 by the core 42 (#00) and the core 42 (#01). First, the core 42 (#00) starts the processing on the first pixel (N1) in the line L1 (see FIG. 5A) when dummy data is sequentially inputted from the bridge 44 and it has been determined that the previous-stage FIFO 54 has become full. The target pixel is then shifted, and the processing is carried out in order on the pixels N2 and N3 (FIGS. 5B and 5C). Meanwhile, after the pixel N3 has been processed and the processing target value N has exceeded 3, the error of the following two pixels that have exited the error diffusion range due to the shift in the target pixel is outputted to the later-stage FIFO 58, and the pixels N4, N5, and N6 are processed in order (FIGS. 5D through 5F). This is the reason that it is determined whether or not the processing target value N is greater than 3 in the determination in step S150 of the aforementioned binarization processing routine. Meanwhile, the core 42 (#01) does not determine that the previous-stage FIFO 54 is full as long as the error is not outputted from the core 42 (#00), and thus is initially in a standby state, and does not carry out processing (FIGS. 5A through 5E). When a total of six pixels' worth of error is outputted from the core 42 (#00) and stored in the previous-stage FIFO 54 (FIG. 5F), the processing of the first pixel (N1) is started (FIG. 5G). In this manner, the error diffusion range of the following core 42 (#01) and the error diffusion range of the previous core 42 (#00) do not overlap when the processing starts, which makes it possible to prevent complicating the processing due to overlaps in the error diffusion ranges. This is why the processing of the first pixel is started after the previous-stage FIFO 54 has become full.

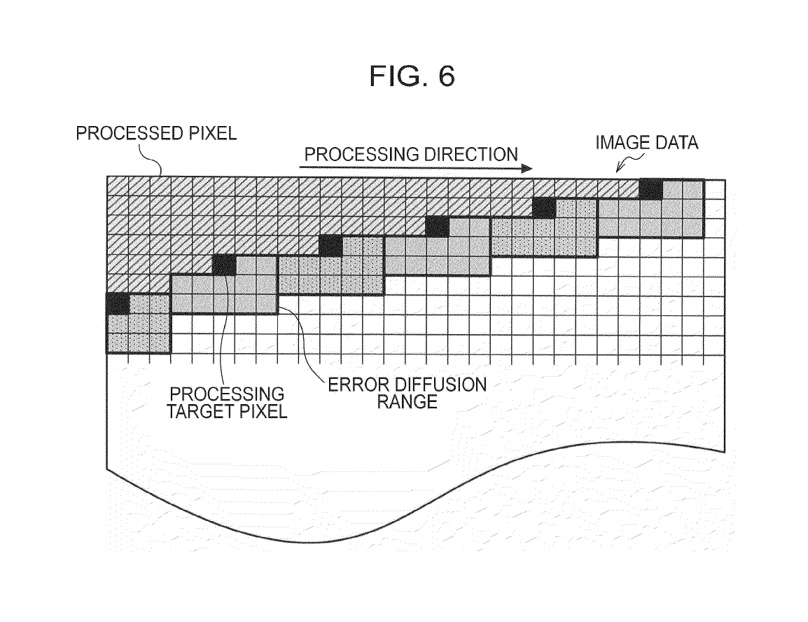

From FIG. 5G and on, the core 42 (#00) shifts the target pixel under the condition that there is an opening in the later-stage FIFO 58, and processes the pixel N7 (FIG. 5H), and the core 42 (#01) shifts the target pixel under the condition that the error has been stored in the previous-stage FIFO 54, and processes the pixel N2 (FIG. 5I). Through this, it is possible to prevent the error carried over from the previous core 42 (#00) to the following core 42 (#01) not being outputted, to prevent the following core 42 (#01) from skipping the previous core 42 (#00) and carrying out processing, and so on. In this manner, the cores 42 are restricted by the processing states of their previous and following cores 42, and the lines are thus sequentially processed in parallel. Here, FIG. 6 is a descriptive diagram illustrating a binarization process carried out on an entire image. As shown in FIG. 6, the binarization processing of the lines is carried out in parallel, with pixels delayed by five lines' worth of pixels corresponding to the error diffusion range from the target pixel in the previous line being taken as the target pixels. Meanwhile, in this embodiment, the plurality of cores 42 are connected in pipeline form via the previous-stage FIFO 54 and the later-stage FIFO 58 and the error is carried over into the following core 42, and thus the processing time can be shortened compared to a case in which the error carried over to the following core 42 is outputted to an external memory such as the main memory 34a, loaded by the core 42 from the external memory, and processed. Accordingly, using the plurality of cores 42, the lines can be smoothly processed in parallel while reflecting the error appropriately on the unprocessed pixels, and thus the binarization process using error diffusion can be carried out more quickly. Furthermore, in this embodiment, a pipeline processor 40 configured of a plurality of cores 42 in this manner is provided for each color, which makes it possible to carry out the binarization process for each CMYK color in parallel at the same time; this in turn makes it possible to carry out the binarization process on an entire image more quickly. Note that the error outputted from the final core 42 (#31) is outputted via the bridge 46 to the main memory 34a, which is an external memory, and thus it is necessary for the bridge 44 to load the error from the main memory 34a for the core 42 (#00) that processes the following line in the lines processed by the final core 42 (#31). However, the error that is required to be outputted to the external memory in this manner can be assumed to be only the error from the final core 42 (#31) of the plurality of cores 42, and thus a large delay in the overall processing time can be suppressed.

Here, the correspondence relationships between the constituent elements of this embodiment and the constituent elements of the invention will be clarified. The core 42 that partially configures the pipeline processors 40 of the image processing processor 32 that executes the binarization processing routine shown in FIG. 4 of the embodiment corresponds to a “processing unit” according to the invention. Meanwhile, the previous-stage FIFO 54 of the core 42 corresponds to a “previous-level buffer” and the later-stage FIFO 58 of the core 42 corresponds to a “later-level buffer”.

The printer 20 according to the embodiment as described thus far includes a plurality of cores 42 that carry out binarization processes while shifting a target pixel from the first pixel in a processing line in order toward the last pixel in the processing line in accordance with a diffusion of error that takes unprocessed pixels surrounding the target pixel as a diffusion range including the following line of the processing line; of the plurality of cores 42, the core 42 that processes the following line carries out the binarization process in order while delaying the target pixels at least by an amount equivalent to the diffusion range relative to the target pixel of the core 42 that processes the previous line. Accordingly, the lines can be processed in parallel while reflecting the error appropriately on the unprocessed pixels, and thus the binarization process using error diffusion can be carried out more quickly.

Meanwhile, the plurality of cores 42 are connected in pipeline form via the previous-stage FIFO 54 and the later-stage FIFO 58 and the error is carried over into the following core 42, and thus the processing time can be shortened compared to a case in which the error carried over to the following core 42 is outputted to an external memory such as the main memory 34a. Furthermore, because the processing is carried out under the condition that there is an opening in the later-stage FIFO 58, it is possible to prevent the error carried over into the following core 42 from being unable to be outputted. Furthermore, because the processing is carried out under the condition that the error has been stored in the previous-stage FIFO 54, it is possible to prevent the following core 42 from skipping the previous core 42. In addition, because the processing of the first pixel is started after the six pixels' worth of error has been stored in the previous-stage FIFO 54, it is possible to prevent the error diffusion range of the following core 42 and the error diffusion range of the previous core 42 from overlapping when the processing is started. Furthermore, because a pipeline processor 40 configured of a plurality of cores 42 is provided for each color, it is possible to carry out the binarization process for each color in parallel at the same time.

Note that the invention is not intended to be limited in any way to the foregoing embodiment, and it goes without saying that the invention can be carried out in various forms within the technical scope thereof.

Although the aforementioned embodiment describes the previous-stage FIFO 54 as having six stages, the invention is not limited thereto, and there may be fewer or more than six stages. Likewise, although the later-stage FIFO 58 is described as having two stages, the invention is not limited thereto, and there may be one stage or more than two stages. The number of stages in the FIFOs may be determined in accordance with the error diffusion range, the processing speeds of the cores 42, and so on. Note, however, that because the processing standby time resulting from standing by for the error to be outputted to the following core 42 corresponds to the input of the error from the previous core 42, it is preferable for the previous-stage FIFO 54 and the later-stage FIFO 58 to each have at least two stages.

Although the aforementioned embodiment describes the core 42 as including the previous-stage FIFO 54 and the later-stage FIFO 58, the invention is not limited thereto, and the core 42 may not include one of the previous-stage FIFO 54 and the later-stage FIFO 58, or may include neither. In this case, the error outputted from the previous core 42 may be stored in the memory 51, the register 56, or the like.

Although the aforementioned embodiment describes the core 42 as carrying out the binarization process on the first pixel under the condition that the previous-stage FIFO 54 is full, the invention is not limited thereto, and the binarization process on the first pixel may be carried out under another condition. For example, the time from the start of the processing by the core 42 (#00) may be measured, and the processing may be started by each core 42 when an amount of time that is shifted by a predetermined amount for each core 42 has elapsed. Furthermore, each core 42 may start the binarization processing routine when such a condition is fulfilled.

Although the aforementioned embodiment describes disposing the bridge 44 before the core 42 (#00) and outputting dummy data, error data, or the like to the core 42 (#00), the invention is not limited thereto, and the core 42 (#00) may input dummy data, error data, or the like itself. In such a case, the data loader 53 of the core 42 (#00) may be provided with such functionality. In addition, although the embodiment describes the bridge 46 as being disposed after the core 42 (#31) and the error from the core 42 (#31) being outputted to the main memory 34a, the invention is not limited thereto, and the core 42 (#31) may output the error itself. In such a case, the data loader 53 of the core 42 (#31) may be provided with such functionality. Alternatively, although the final core 42 (#31) and the first core 42 (#00) are described as not being connected, the final core 42 (#31) and the first core 42 (#00) may be connected via a FIFO, and in such a case, the error resulting from the processing of the final core 42 (#31) may be directly inputted into the first core 42 (#00).

Although the aforementioned embodiment describes the unprocessed pixels in a 5×5 range of pixels central to the target pixel (a total of 12 pixels) as the error diffusion range, the invention is not limited thereto, and any range may be used as long as the range contains the pixels of the following line of the lines to be processed; for example, the unprocessed pixel in a 3×3 range central to the target pixel (a total of four pixels) may be used as the error diffusion range.

Although the aforementioned embodiment describes carrying out the processing in order from the pixel on the left to the pixel on the right, the invention is not limited thereto, and the processing may be carried out in order from the pixel on the right to the pixel on the left. Furthermore, although the embodiment describes carrying out the processing in order from the line at the top to the line at the bottom, the invention is not limited thereto, and the processing may be carried out in order from the line at the left to the line at the right; in such a case, the processing may be carried out in order from the pixel at the top to the pixel at the bottom, or may be carried out in order from the pixel at the bottom to the pixel at the top.

Although the ink colors have been described as four colors, or cyan (C), magenta (M), yellow (Y), and black (K), in the above embodiment, the invention is not limited thereto, and five or six colors, including light cyan (LC), light magenta (LM), or the like may be employed, or even more colors may be employed. In such a case, the same number of pipeline processors 40 as there are colors may be provided. Furthermore, the invention is not limited to carrying out a binarization process on color image data, and the binarization process may be carried out on monochromatic image data.

Although the aforementioned embodiment describes the image forming apparatus according to the invention being applied in an ink jet printer 20, the invention is not limited thereto, and may also be applied in a laser printer. Furthermore, the invention may be applied in a complex machine that includes a fax function, a copy function, and so on in addition to a printer function. Furthermore, the image processing processor 32, which serves as the image processing apparatus according to the invention, it is not limited to being installed in the printer 20, and may be implemented as a standalone image processing apparatus.

What is claimed is:

1. An image processing apparatus that carries out a binarization process through error diffusion on the pixels of multitone image data in order from a leading line to a final line, comprising:
a plurality of processing units that carry out binarization processes while shifting a target pixel from the first pixel in a processing line in order toward the last pixel in the processing line in accordance with a diffusion of error that takes unprocessed pixels surrounding the target pixel including the pixels of the following line of the processing line as a diffusion range,
wherein of the plurality of processing units, the processing unit that processes the following line carries out the binarization process in order while delaying the target pixel at least by an amount equivalent to the diffusion range relative to the target pixel of the processing unit that processes the previous line.

2. The image processing apparatus according to claim 1, wherein each of the plurality of processing units includes a first in-first out buffer, is connected in pipeline form to the processing unit that processes the following line via the buffer, and outputs the error of a pixel that has exited the diffusion range due to the shift in the target pixel to the buffer.

3. The image processing apparatus according to claim 2, wherein the plurality of processing units each includes, as the buffer, a later-level buffer between the processing units that process the following lines, and the target pixel is shifted under the condition that an opening has appeared in the later-level buffer.

4. The image processing apparatus according to claim 2, wherein the plurality of processing units each includes, as the buffer, a previous-level buffer between the processing units that process the previous lines, and the target pixel is shifted under the condition that the error is stored in the previous-level buffer.

5. The image processing apparatus according to claim 1, wherein the plurality of processing units start the binarization process on the processing lines under the condition that the target pixel of the processing unit that processes the previous line has been shifted at least more than an amount equivalent to the diffusion range from the start of the processing line.

6. The image processing apparatus according to claim 1, using color image data configured of a plurality of color components as the image data,
wherein a processing unit group configured of the plurality of processing units is provided for each of the plurality of color components.

7. An image forming apparatus, comprising the image processing apparatus according to claim 1, that forms an image on a medium using data that has been binarized by the image processing apparatus.

8. An image forming apparatus, comprising the image processing apparatus according to claim 2, that forms an image on a medium using data that has been binarized by the image processing apparatus.

9. An image forming apparatus, comprising the image processing apparatus according to claim 3, that forms an image on a medium using data that has been binarized by the image processing apparatus.

10. An image forming apparatus, comprising the image processing apparatus according to claim 4, that forms an image on a medium using data that has been binarized by the image processing apparatus.

11. An image forming apparatus, comprising the image processing apparatus according to claim 5, that forms an image on a medium using data that has been binarized by the image processing apparatus.

12. An image forming apparatus, comprising the image processing apparatus according to claim 6, that forms an image on a medium using data that has been binarized by the image processing apparatus.
